(19) United States
(12) Patent Application Publication
(10) Pub. No.: US 2006/0165071 A1
(43) Pub. Date: Jul. 27, 2006

(54) Weight adaption in packet switches

(75) Inventors: Andries Van Wageningen, Wijlre (NL); Hans-Juergen Reumerman, Aachen (DE); Armand Lelkens, Heerlen (NL); Joern Ungermann, Aachen (DE); Rainer Schoenen, Aachen (DE)

Correspondence Address: PHILIPS INTELLECTUAL PROPERTY & STANDARDS, P.O. BOX 3001, BRIARCLIFF MANOR, NY, 10510, US

(73) Assignee: KONINKLIJKE PHILIPS ELECTRONCIS N.V., BA Eindhoven (NL)

(21) Appl. No.: 10/526,315

(22) PCT Filed: Sep. 23, 2003
(86) PCT No.: PCT/IB03/04133

§ 371 Date: Mar. 29, 2005

(30) Foreign Application Priority Data
Oct. 2, 2002 (EP) 0102407.0

(51) Int. Cl. H04Q 11/00

(52) U.S. Cl. 370/380; 370/428

(57) ABSTRACT

The invention relates to a method, a packet switched and a use of a packet switch for configuring a cross-connection matrix within switching means based on status information provided by port controllers of input/output means. By providing generic functions within an arbiter to change weight-values provided by the port controller in order to anticipate the effect of the arbitration result to the weight-values, the bandwidth for status information communication may be reduced.

The invention relates to a method for configuring a cross-connection matrix with switching means based on status information provided by port controllers of input/output means. The invention further relates to a packet switch comprising at least one input/output means with at least one port controller, at least one switching means with at least one arbiter and at least one cross-connection means, said port controller comprising at least one virtual output queue, queuing cells for communication with other port controllers via said switching means, said arbiter comprising a configuration means for configuring said switching of said cross-connection means, and where said cross-connection means switch incoming cells from one input/output means to one other input/output means. Furthermore, the invention relates to the use of such a method or such a packet switched.

A packet switch for switching packets between nodes of communication networks may comprise input queues and switch cards. The input queues may be organised as virtual output queues (VOQs) to avoid head of line blocking. A line card comprises a port controller, realising these virtual output queues.

The port controller on an line card has the task to queue incoming cells and to organise these cells according to their type, priority and/or desired destination. The desired destination is the output port of the packet switch. The queuing of incoming cells via virtual output queues is well known, and avoids head of line blocking within the input queues. For each virtual output queue the port controller calculates a weight value. This weight value may be based on the length of, or the age of the head of line cell within the respective virtual output queues.

The packet switch further comprises switch cards, which may comprise cross-connection means, such as a bufferless cross-point matrix, which function is to connect different line cards with each other. Further a switch card may comprise an arbiter, which function is to calculate the input/output configuration of the cross-point matrix at regular intervals, e.g. cell periods. These cell periods may be defined by the clock frequency of the port controllers. Received data packets are segmented into fixed sized packet fragments, so called cells, at the ingress of the line cards. These cells are reassembled back to data packets at the egress of the line cards. Within a packet switch only cells have to be handled.

The arbiter tries to calculate an optimised input/output configuration of the cross-connection means for each cell period. This calculation has the restriction that it may not connect multiple input ports to one output port, or multiple output ports to one input port during one cell period. The calculation of the arbiter is based on the information received from the port controllers on the line cards, where the cells are waiting to be transported through the switch cards. In known packet switches the arbiter keeps a copy of all actual state information it has received from the port controllers. The result of an arbitration, which grants the transportation of a cell from an input port to an output port, is sent to the port controllers by the arbiter at each period.

Therefore, the arbiter on the switch card works in close co-operation with the port controllers on the line cards. Each port controller sends a regular update of the virtual output queue states to the arbiter on the switch card. The arbiter keeps a copy of the actual state information it received from the port controllers. Based on the virtual output queue state information received from the port controllers, the arbiter calculates the input/output configuration of the cross-point matrix. The result of this arbitration is sent to the cross-point matrix and to the port controllers at every cell period. Based on the configuration the cross-point matrix switches cells from input ports to output ports during an arbitration step.

Within high speed systems the bandwidth used for updating the virtual output queue state information might be problematic, as many updates are required.

In case the arbiter itself keeps a copy of each virtual output queue state information, the arbiter would become very complex, as it has to keep track of all virtual output queue state information of all port controllers. Furthermore, in case of arbiter failures, the state information will be lost within the arbiter.

On the other hand, in case the arbiter fully depends on the state information received from the port controllers, at least two state updates have to be transferred between arbiter and every port controller within one cell period, one for an incoming cell and one for an outgoing cell.

It is an object of the invention to provide a packet switch using low bandwidth for status information transfer between switch card and line card and providing a fail-safe arbiter. It is a further object of the invention to provide a simple arbiter architecture. It is yet a further object of the invention to reduce latency time within the arbiter.

These and other objects of the invention are solved by a method for configuring a cross-connection matrix within switching means based on status information provided by port controllers of input/output means, where said port controllers provide status information of their virtual output queues within status words to said switching means, said switching means store status information within status information fields of a status matrix, and an arbiter within said switching means configures said cross-connection matrix based on said status information stored within said status information fields.

The intelligence of virtual output queue state information handling and generation is within the port controller. The arbiter is fail-safe as status information will be stored within status information fields within a status matrix. This status matrix may be changed by the arbiter based on the arbitration results.

Switching means may be a switch card as described previously. Input/output means may be a line card as also described previously. Said status matrix may be a random access memory. Each field of the status matrix may represent one connection between one input port and one output port. The row of the matrix may represent the respective input port and the column of the matrix may represent the respective output port of a cross-connection matrix, or vice versa.

A method according to claim 2 is further preferred. The status word, which is sent by the port controller to the arbiter, may comprise communication information. This communication information may be an output port number indicating the output port being the destination of a respective cell of the VOQ. Each element of the status matrix is addressed by the number of the port controller from which the arbiter receives the status words and an output port number being the destination of a respective cell. This destination information is comprised within the status words as communication information. Depending on the communication information stored within the status matrix, the arbiter may configure said cross-connection matrix, which means that cells from certain input ports are switched to certain output ports.

A method according to claim 3 is also preferred. The weight information may indicate the priority of a cell of the respective virtual output queue. This weight information may be determined by the length of the virtual output queue, e.g. the number of cells within the virtual output queue, or the age of the head of line cell of the virtual output queue. The age might be determined by the number of cell periods the first cell of said virtual output queue waits to be switched to the respective output port. It is understood that any other priority information may be used as weight information.

A method according to claim 4 is yet another preferred embodiment of the invention. The arbiter may use type information within a type field of the status word as an instruction what to do with the weight information stored within the status information field of the status matrix. The arbiter supports different instructions of the port controller being determined by the type field of the status word. Some of these functions may be as follows:

Decrement weight information with n. If the weight information is determined by the length of a virtual output queue, the weight information is decremented after a successful arbitration for this virtual output queue. The transport of a cell from this virtual output queue to the output port will decrease the queue-length. This function is preferred according to claim 5.

Increment weight information by one according to claim 6. If the weight is determined by the age of the head of line cell of a virtual output queue, the weight increases after a non-successful arbitration for this virtual output queue. In case the cell remains within the virtual output queue, its age increases. Within the status information field of the status matrix, the weight will be increased by one and the arbiter thus knows that the age of the head of line cell is increased by one.

Reset the weight information within the status information field of the status matrix as proposed by claim 7. This may be the case if the weight is determined by the age of the head of line cell of the virtual output queue, and the weight is set to zero after a successful arbitration for this virtual output queue. When a cell is transported to the output port the age of the next cell in the virtual output queue determines the weight stored in the respective status information field, as long as this queue is not empty.

By providing the arbiter with generic functions, preferably as described above, to change the status information field, most of the intelligence may be kept within the port controllers for virtual output queue state information handling and weight generation. By adding some intelligence to the arbiter for updating the virtual output queue state information within the status matrix, the bandwidth for virtual output queue state information update may be reduced, as an update from the VOQs after arbitration will become superfluous.

Preferably the status word comprises three data fields, one for communication information, one for weight information and one for type information. This status word may not necessarily be transferred between VOQ and arbiter after each arbitration, as the information is updated within status matrix according to the type information by the arbiter itself.

A further aspect of the invention is a packet switch characterised in that said arbiter comprises a status matrix with status information fields for each input/output combination between said input/output means, said status information fields carry status information of said virtual output queues provided by the port controllers determining the status of said virtual output queues, said configuration means configures said cross-connection matrix based on said status information within said status information fields.

It is yet a further aspect of the invention to use a pre-described method or a pre-described packet switch in packet switched networks, in local area networks, in wide area networks, and in mobile communication networks.

By providing generic functions within an arbiter to change weight-values provided by the port controller in order to anticipate the effect of the arbitration result to the weight-values, the bandwidth for status information communication may be reduced.

These and other aspects of the invention will be apparent from and elucidated with reference to the following figures. In the figures show:

FIG. 1 a packet switch configuration;

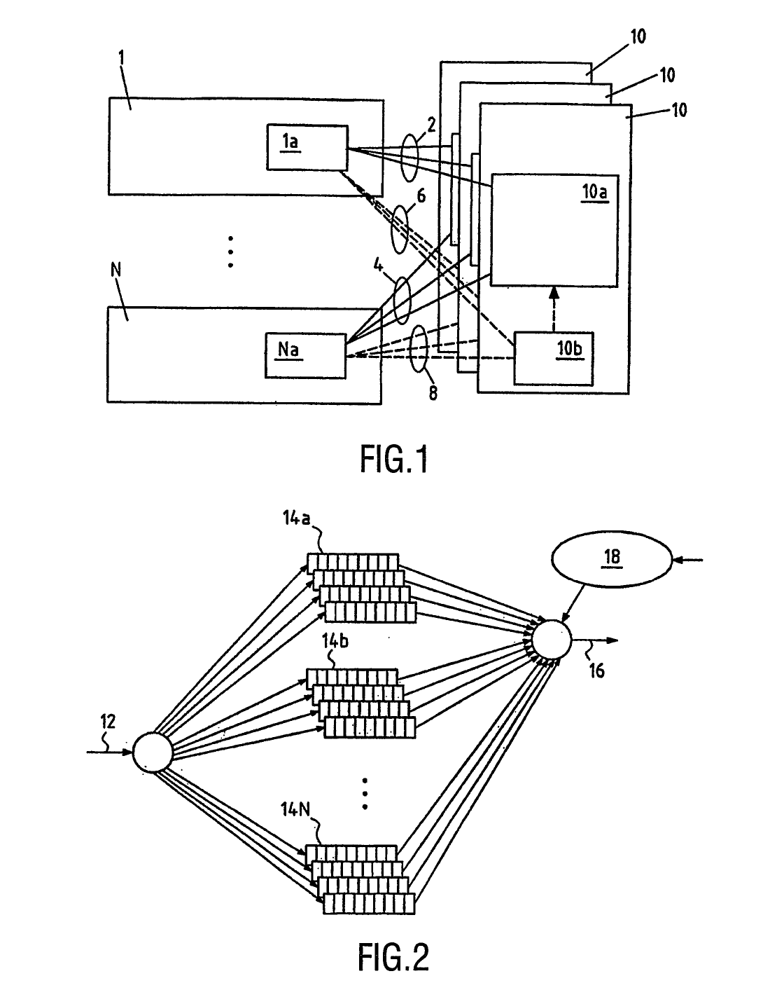

FIG. 2 virtual output queues in port controllers;

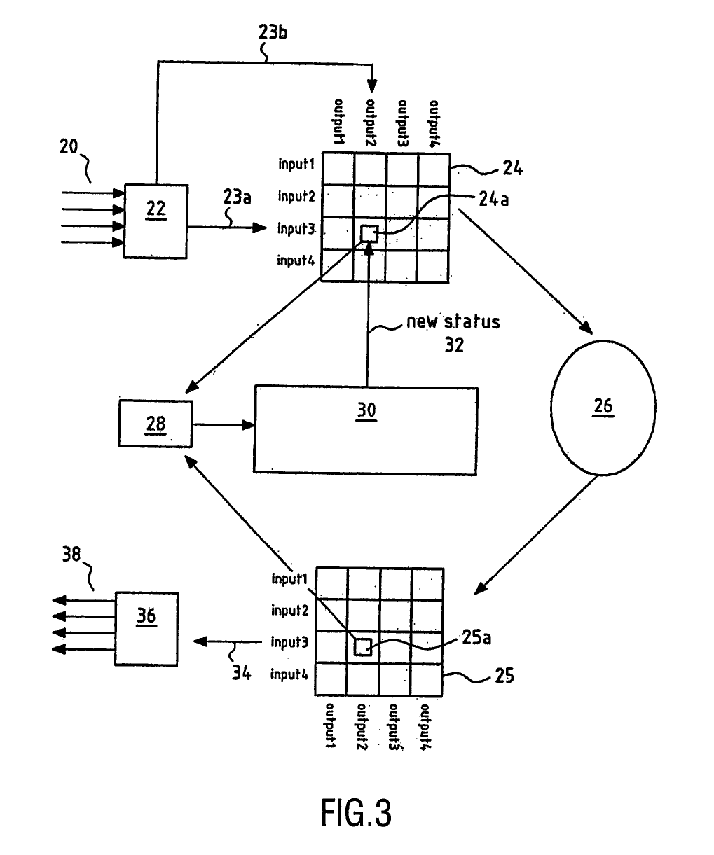

FIG. 3 an arbitration according to the invention.

In FIG. 1, a known packet switch is depicted. A plurality of line cards 1-N is connected to a plurality of switch cards 10. The line cards 1-N communicate with the switch cards 10 by using port controllers 1a-Na. The port controllers 1a-Na send data cells to, and receive data cells from the switch cards 10 via connection lines 2, 4. The state information of the output queues of the port controllers 1a-Na are communicated to arbiters 10b via communication lines 6, 8. The arbiters 10b decide which line cards 1-N are connected with each other via the lines 4, 2 to transmit respective cells in the output queues of the port controllers 1a-Na.

The transmission of cells between port controllers 1a-Na is switched by setting a cross-connection matrix 10a appropriately. Input ports of the switch cards 10 are represented by lines in the cross-connection matrix 10a. Output port of the switch cards 10 are represented by columns in the cross-connection matrix 10a. To connect, for example, input port “1” with output port “3”, a switch located at line 1 and column 3 of matrix 10a is set “on”.

FIG. 2 depicts the generation and handling of cells within virtual output queues. Incoming cells are provided 12 to the virtual output queues 14 of the port controllers. For each output of a port controller, a virtual output queue 14a-14N is handled within the respective port controller.

The weight of the virtual output queues 14 may be determined by the number of cells which are stored within the virtual output queues 14. The age of a cell may be determined by the number of cell period, a cell remains within a virtual output queue. To determine which cell of which virtual output queue 14 will be sent to the respective output port, a decision handler 18 determines the virtual output queue 14 providing the outgoing cell 16. With each incoming cell 12 the state of the virtual output queues 14 changes, as well as with each outgoing cell 16. The state change depends on the decisions made by the decision handler which may be controlled by the arbiter.

FIG. 3 depicts an arbitration method according the invention. The switch cards receive from port controllers status words, describing the status of respective VOQs of the port controllers. Incoming status words 20 from the port controllers are analysed within status analyser 22. The status analyser determines from the status words output port number information, weight information, and function type information. The output port number information addresses to the status matrix 24 via information transfer 23b. In the depicted case, the output port information concerns output port number 2, which is depicted by indicating cell 2 of the status matrix 24. Further, input port information describing the input port of a respective status word is retrieved within status analyser 22, and addresses a status matrix 24 via information transfer 23a. In the depicted case, the input port is port number 3, as indicated by row input 3.

Within status matrix 24 status information field 24a is indicated. This status information field 24a carries weight information of virtual output queue connected to input port 3 and type information determining the function type handling the stored weight information. Weight and type information are fed from 22 to 24 at location addressed by 23a, 23b.

During arbitration 26 the arbiter (not depicted) decides which input port will be switched to which output port, depending on the weight information stored within the status information fields within status matrix 24. It is preferred that cells from the virtual output queue with the highest weight will be switched first. After arbitration 26 the status information field 24a will be changed according to the arbitration result and the new weight-value will be stored (overwritten) in status information field 24a. Result matrix 25 is a representation of input/output connection calculated by arbitration 26. The input port and output port information is transferred to grant generator 36 by information transfer 34. Grant generator 36 grants the switching between respective input ports and output ports 38 to a cross-connection matrix (not depicted) and the port controller.

A code analyser 28 determines from arbitration result information field 25a, whether an arbitration process has been successful. Furthermore, the code analyser 28 determines the type information stored in status information field 24a. Depending on the type information a function generator 30 is controlled. The functions supported by function generator 30 may be:

Decrement the weight stored in status information 24a after a successful arbitration for this virtual output queue. The new weight information is stored in status information field 24a.

Increment the weight of an virtual output queue. The weight information in status information field 24a is increased and the increased weight-value stored in status information field 24a after a non-successful arbitration.

Reset the weight information. The value is set to zero after a successful arbitration for this virtual output queue. By that a weight-value stored in status information field 24a is set to zero.

By carrying out the function on the status information stored in the status matrix, new status information about port controllers is retrieved within the status matrix 24 without updating the information from the port controllers. This saves bandwidth and provides fail-safe arbitration.

### REFERENCE SIGNS

1, N line card
1a, Na port controller
2, 4 transmission connection
6, 8 signalling connection
10 switch card
10a cross-connection matrix
10b arbiter
12 incoming cell
14 virtual output queue
16 outgoing cell
18 decision handler
20 status word
22 status analyser
23 information transfer
24 status matrix
24a status information field
26 arbitration
28 code analyser
30 function
32 change of information
34 information transfer
36 grant generator
38 grant to input ports

1. Method for configuring a cross-connection matrix within switching means based on status information provided by port controllers of input/output means,
where said port controllers provide status information of their virtual output queues within status words to said switching means,
said switching means store said status information within status information fields of a status matrix, and
an arbiter within said switching means configures said cross-connection matrix based on said status information stored within said status information fields.

2. Method according to claim 1, characterised in that said status word comprises communication information, and that said arbiter configures said cross-connection matrix based on said communication information.

3. Method according to claim 1, characterised in that said status word comprises weight information, and that said arbiter configures said cross-connection matrix based on said weight information.

4. Method according to claim 1, characterised in that said status word comprises type information, and that said arbiter changes said status information within said status information fields based on said type information and the arbitration result.

5. Method according to claim 1, characterised in that said arbiter decrements weight information of said status information within said status information fields in case of a successful arbitration.

6. Method according to claim 1, characterised in that said arbiter increments weight information of said status information within said status information fields in case of a non-successful arbitration.

7. Method according to claim 1, characterised in that said arbiter resets weight information of said status information within said status information fields in case of a successful arbitration.

8. Packet switch comprising
at least one input/output means with at least one port controller,
at least one switching means with at least one arbiter, and at least one cross-connection means,
said port controller comprising at least one virtual output queue, queuing cells for communication with other port controllers via said switching means,
said arbiter comprising configuration means for configuring said switching of said cross-connection means, and
where said cross-connection means switch incoming cells from one input/output means to one other input/output means, characterised in that
said arbiter comprises a status matrix with status information fields for each input/output combination between said input/output means,
said status information fields carry status information of said virtual output queues provided by the port controllers determining the status of said virtual output queues,
said configuration means configure said cross-connection matrix based on said status information within said status information fields.

9. Use of a method according to claim 1 or a packet switch according to claim 8 in packet switched networks, in local area networks, in wide area networks, and in mobile communication networks.
